(19) United States
(12) Patent Application Publication
(10) Pub. No.: US 2025/0372919 A1
(43) Pub. Date: Dec. 4, 2025

(54) CONNECTOR ASSEMBLY WITH MAGNETIC GUIDES

(71) Applicant: Advanced Micro Devices, Inc., Santa Clara, CA (US)

(72) Inventor: Manish DUBEY, Austin, TX (US)

(21) Appl. No.: 18/679,346

(22) Filed: May 30, 2024

(51) Int. Cl. H01R 13/62; H01R 13/631; H01R 13/639

(52) U.S. Cl. CPC H01R 13/6205; H01R 13/631; H01R 13/639

(57) ABSTRACT

Disclosed herein are a connector assembly and an integrated circuit package assembly including the connector assembly. The connector A connector assembly includes a male connector comprising a first side wall protecting a plurality of pins, the first side wall comprising a first magnetic component contained in a side surface of the first side wall; and a female connector comprising a second side wall protecting a plurality of sockets configured to receive the plurality of the pins, the second side wall comprising a second magnetic component contained in a side surface of the second side wall. The first magnetic component and the second magnet component are configured to be disposed adjacent to each other when the male connector engages with the female connector.

### TECHNICAL FIELD

Embodiments of the present invention generally relate to a connector assembly, and, and in particular, to a connector assembly having magnetic guides.

### BACKGROUND

The adoption of high speed serializer/deserializer (“SERDES”) channels in an IC package assembly has run into many issues due to losses associated with long route lengths, skin effects, insufficient ground referencing, power intermixing etc. Co-packaged optics, such as flyover cables, and co-packaged electrical connectors are used in an IC package to transmit signals from the integrated circuit package with minimal loss.

However, the mechanical integration of co-packaged optics and connectors with an IC package has many challenges. For example, connectors not only become smaller, but also are densely packed to reduce the footprint of these devices. As a result, the workspace available for a technician to handle these connectors during installation is very small. As a result, the risk of damaging costly silicon and other components adjacent to the connectors during installation these connectors is undesirably high.

Therefore, a need exists for an improved connector assembly for an IC package assembly.

### SUMMARY

Disclosed herein are a connector assembly and an integrated circuit package assembly including the connector assembly. In an example, the connector assembly includes a male connector comprising a first side wall protecting a plurality of pins, the first side wall comprising a first magnetic component contained in a side surface of the first side wall; and a female connector comprising a second side wall protecting a plurality of sockets configured to receive the plurality of the pins, the second side wall comprising a second magnetic component contained in a side surface of the second side wall. The first magnetic component and the second magnet component are configured to be disposed adjacent to each other when the male connector engages with the female connector.

According to one or more embodiments, the first magnetic component has a first magnetic axis traversing an engaging direction of the connector assembly. The second magnetic component has a second magnetic axis configured to be parallel with the first magnetic axis. The first magnetic axis and the second magnetic axis are reversed relative to each other.

According to one or more embodiments, the female connector is configured to enclose the male connector, and the first magnetic component is disposed in an outer surface of the first side wall. The second magnetic component is disposed in an inner surface of the second side wall. The first magnetic component is disposed in proximity to an end surface of the first side wall facing the second side wall, and the second magnetic component is disposed in proximity to an end surface of the second side wall facing the first side wall.

According to one or more embodiments, the male connector comprises a third side wall comprising a third magnetic component, and the third magnetic component has a third magnetic axis aligned with a first magnetic axis of the first magnetic component. The female connector comprises a fourth side wall comprising a fourth magnetic components, and the fourth magnetic component has a fourth magnetic axis reversing that of the third magnetic component.

According to one or more embodiments, the first magnetic component has a thickness shorter than that of the first side wall. One of the first and second magnetic components has a larger size than the other one of the first and second magnetic components. The plurality of the pins are coupled with a plurality of cables. The connector assembly further comprises a locking mechanism configured to maintain an engagement position between the male connector and the female connector.

In an example, the integrated circuit package assembly includes a plurality of integrated circuit dice; a stiffener coupled with a package substrate and surrounding the plurality of the integrated circuit dice; and a connector assembly coupled with the stiffener. The connector assembly is configured according to various embodiments of the present disclosure.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross-sectional view of an electronic device having an integrated circuit package assembly with a connector assembly, according to an embodiment of the present application.

FIG. 2 is a schematic top view of the integrated circuit package assembly depicted in FIG. 1, according to an embodiment of the present application.

FIG. 3 is a schematic top view of the integrated circuit package assembly, according to an embodiment of the present application.

FIG. 4a is a schematic cross-sectional view of an unengaged connector assembly, according to an embodiment of the present application.

FIG. 4b is a schematic cross-sectional view of the magnetic components of an engaged connector assembly, according to an embodiment of the present application.

FIG. 5 is a schematic perspective view of a connector assembly, according to an embodiment of the present application.

FIG. 6 is a schematic perspective view of a server machine having a connector assembly, according to an embodiment of the present application.

FIG. 7 is a schematic view of a connector assembly for a network card, according to an embodiment of the present application.

To facilitate understanding, identical reference numerals have been used, where possible, to designate identical elements that are common to the figures. It is contemplated that elements of one embodiment may be beneficially incorporated in other embodiments.

### DETAILED DESCRIPTION

Disclosed herein are a connector assembly and an IC package assembly including the connector assembly. The connector assembly includes a male connector configured to matingly couple with a female connector. The connector assembly may include a mechanical locking mechanism that guides and maintain the engagement between the male and female connectors. To ensure a proper alignment between the connectors, the connector assembly includes a magnetic guide configured to align the male and female connectors even before a physical contract between the two connectors occurs.

The magnetic guides includes one or more pairs of magnetic components: one disposed on the female connector and the other one disposed on the male connector. In an instance where the male and female connectors are roughly in aligned positions, the magnetic components in the same pair are configured to generate a magnetic attraction force to guide the male and female connectors to a proper alignment. In another instance where the male and female connectors are misaligned, the magnetic components in different pairs are configured to generate a magnetic repulsion force to warm a user that the positions are wrong, thus avoiding physical damage to the connector assembly.

The connector assembly can be integrated into an IC package assembly. In an example, the connector assembly may be integrated into the stiffener of the IC package assembly. The connector assembly may also be used in other electrical devices or machines, such as an electronic board, a PCB board, a server machine, and any other suitable devices or machines. The connector assembly may be used for connecting with power cables, data cables, signal cables, audio cables, video cables or any other cables.

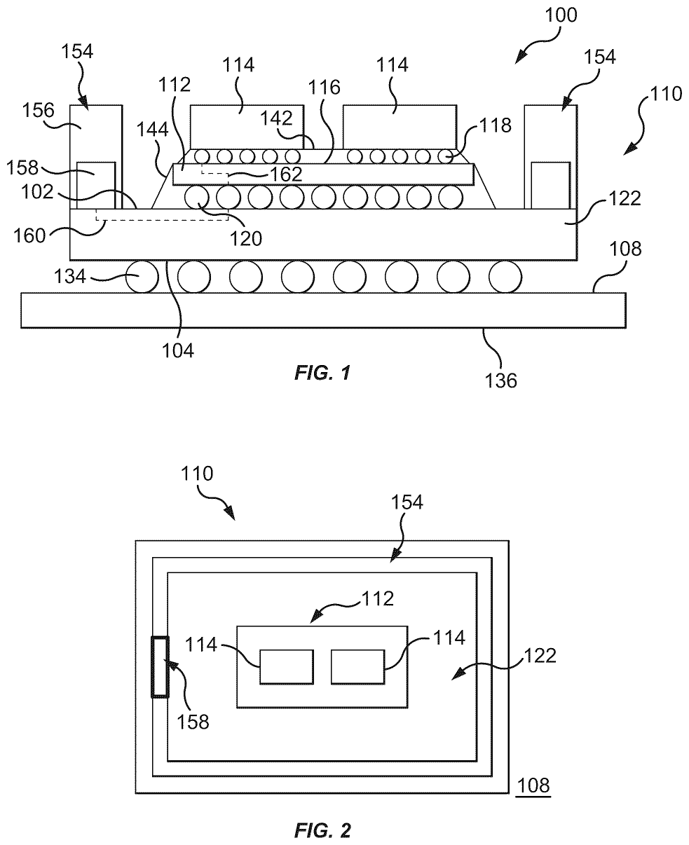

Turning now to FIG. 1, an exemplary integrated circuit package assembly 110 is disposed on a printed circuit board (PCB) 136. The integrated circuit package assembly 110 and the PCB 136 together form at least part of an electronic device 100. The electronic device 100 may be a tablet, computer, copier, digital camera, smart phone, control system, automated teller machine, server or other solid-state memory and/or logic device. The integrated circuit package assembly 110 includes one or more IC dice 114 mounted to an interposer 112. For example, FIG. 1 shows two IC dice 114 are mounted on the interposer 112 side by side. Alternatively, the IC die 114 may be stacked directly on top of each other and then mounted on the interposer 112. In other embodiments, the IC die 114 may be mounted directly to the package substrate 122 without the presence of the interposer 112.

The interposer 112 includes circuitry 1 for electrically connecting the dice 114 to the package substrate 122. The circuitry of the interposer 112 may optionally include transistors and/or other circuit elements. Solder connections 120, also known as or “package bumps” or “C4 bumps,” are utilized to provide an electrical connection between the interposer 112 and the package substrate 122. A bottom surface 104 of the package substrate 122 may be mounted and connected to a top surface 108 of the PCB 136, utilizing connections 134, such as solder balls, wire bonding or other suitable technique. An undermolding 144 may be utilized to fill the space not taken by the connections 120 between the package substrate 122 and the interposer 112.

The IC dice 114 may be programmable logic devices, such as field programmable gate arrays (FPGA), memory devices, optical devices, processors or other IC logic structures. Optical devices include photo-detectors, lasers, optical sources, and the like. In the example depicted in FIG. 1, the IC dice 114 are mounted to a top surface 116 of the interposer 112 by die connections 118. The die connections 118 may be in the form of a plurality of solder joints, also known as “micro-bumps”. The circuitry of the interposer 112 connects the die connections 118 to selective solder connections 120, and hence, connects selective circuitry of each IC die 114 to the package substrate 122, to enable communication of the dice 114 with the PCB 136 after the integrated circuit package assembly 110 is mounted within the electronic device 100.

According to an embodiment, a stiffener 154 is coupled to the package substrate 122 and configured to enhance the warpage resistance of the package substrate 122 against out of plane deformation. The stiffener 154 is generally positioned at the peripheral area, such as edges, of the package substrate 122. The stiffener 154 includes a plurality of walls 156, which may be fabricated from any materials that are suitable to reinforce the stiffness of the package substrate 122. In an example, the walls 516 may be fabricated from a combination of materials selected from metals, ceramics, thermoplastics, glass reinforced plastics, and carbon reinforced materials. The stiffener 154 may have a ring shape, be fabricated in one or more attached sections, or be fabricated in one more attached spaced apart sections.

A connector assembly 158 is integrated with integrated circuit package assembly 110. The connector assembly 158 may be integrated with at least one of the the package substrate 122, the interposer 112, and the stiffener 154. In one example, the connector assembly 158 secured with or by the stiffener 154 to the package substrate 122. The connector assembly 158 is electrically connected (i.e., communicatively coupled) to at least one or more of the IC dice 114 via a circuitry 160 of the package substrate 122 (and a circuitry 162 of the interposer 112, when present). The portion of the connector assembly 158 integrated with the stiffener 154 is one of the male or female connector, while the other of the male or female connector of the portion of the connector assembly 158 forms the termination of a communications cable (not shown).

According to an embodiment, a connector assembly 158 includes a magnetic guide that assists the alignment of a female connector and a male connector that need to be engaged with each other. The magnetic guide includes one or more pairs of magnetic components. For the two magnetic components in the same pair, one magnetic component may be disposed on a female connector, and the other magnetic component may be disposed on the male connector. The two magnet components in the same pair have their respective magnetic axes reversed relative to each other. The reversed magnetic axes cause opposite magnetic poles facing each other, thus generating a magnetic attraction force when the magnetic components of the same pair are disposed adjacent to each other. The pair of magnet components can provide force feedbacks to a technician such that a proper alignment between the male and female connectors can be assured.

As shown in FIG. 2, the stiffener 154 is generally disposed around the perimeter of the package substrate 122. One or more dice 114 are supported by the interposer 112, which is supported by the package substrate 122. The stiffener 154 may be a single continuous ring, be made from a plurality of wall segments, or be made from a plurality of spaced-apart wall segments. According to an embodiment, the stiffener 154 forms an enclosure that surrounds the IC dice 114. The connector assembly 158 integrated with the stiffener 154 is also shown in FIG. 2. According to an embodiment, the connector assembly 158 is configured to have a footprint substantially bounded by the walls of the stiffener 154 to reduce the size of the integrated circuit package assembly 110.

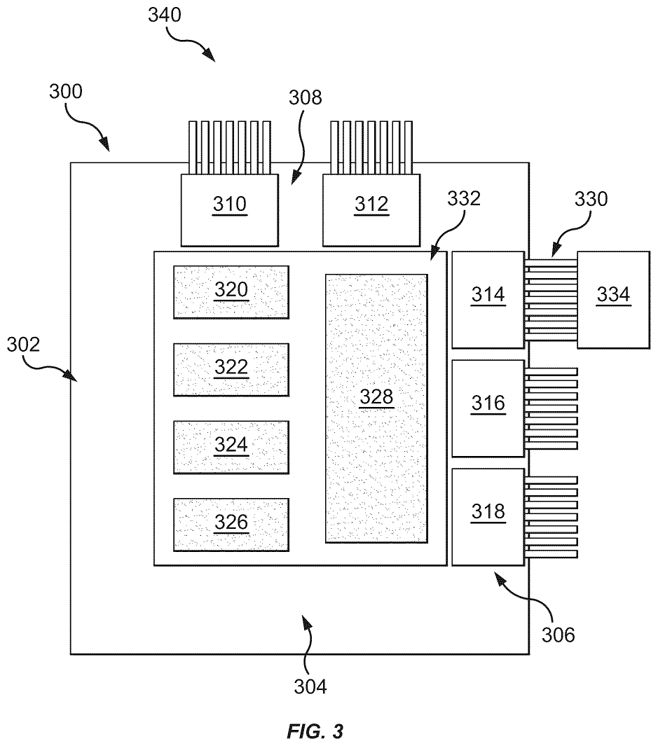

FIG. 3 illustrates a schematic top view of an integrated circuit package assembly 340, having a stiffener 300 having at least one or more connector assemblies according to an embodiment. The integrated circuit package assembly 340 includes a plurality of IC dice 320-328 mounted to a substrate 332. An interposer, not shown in FIG. 3, may be disposed between substrate 332 and the IC dice 320-328. The stiffener 300 is mounted to the substrate 332. The stiffener 300 is integrated with one or more one or more connector assemblies, shown as connector assemblies 310, 312, 314, 316, 318. However, one to as many connector assemblies can be physically accommodated may alternatively be utilized. The connector assemblies 310, 312, 314, 316, 318 are coupled to the stiffener 300, for example, using an adhesive, such as an epoxy. The connector assemblies 310, 312, 314, 316, 318 are electrically coupled to the circuitry of the substrate 332 such that the connector assemblies 310, 312, 314, 316, 318 are electrically coupled with plurality of IC dice 320-328. In an example, a plurality of cables 330, such as optical cable and electrical cables, can be used to connect an external source 334 disposed outside of the integrated circuit package assembly 340 with the IC dice 320-328. The external source 334 may be disposed in a same electronic device of the IC package assembly 340 or be disposed in a different electronic device. The connector assembly 314 together with the plurality of cables 330 enable high speed communication between the integrated circuit package assembly 340 to the external source 334.

In the example depicted in FIG. 3, the stiffener 300 includes a plurality of wall segments 302-308 enclosing a plurality of IC dice 320-328. The wall segment 308 includes two connector assemblies 310 and 312, and the wall segment 306 includes three connector assemblies 314-316. In an example, the connector assemblies connect flyover cables, such as the cable 330. As shown in FIG. 3, each connector assembly 310-318 is connected with multiple cables, for example seven cables, and is integrated with a corresponding wall segment. A fewer or greater number of connector assemblies may be integrated with the stiffener 300, and that the connector assemblies may be disposed at any desired locations along the stiffener 300.

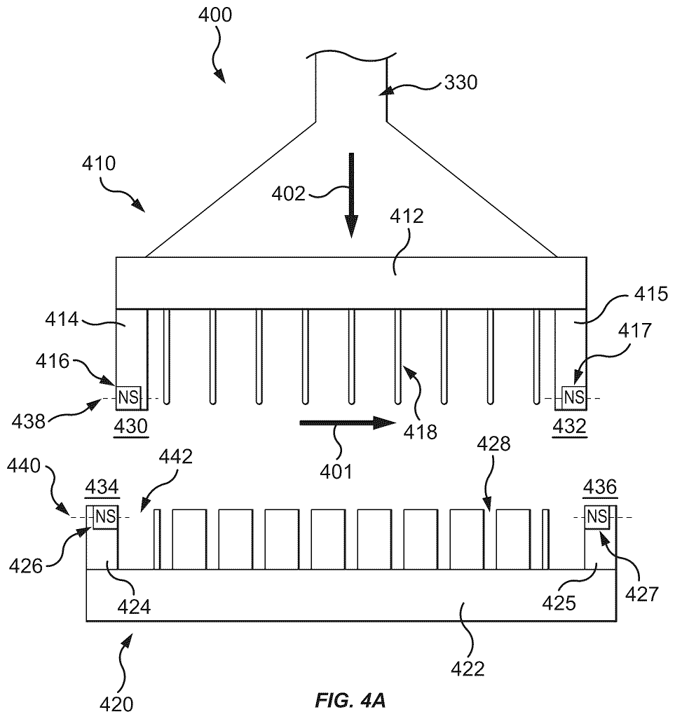

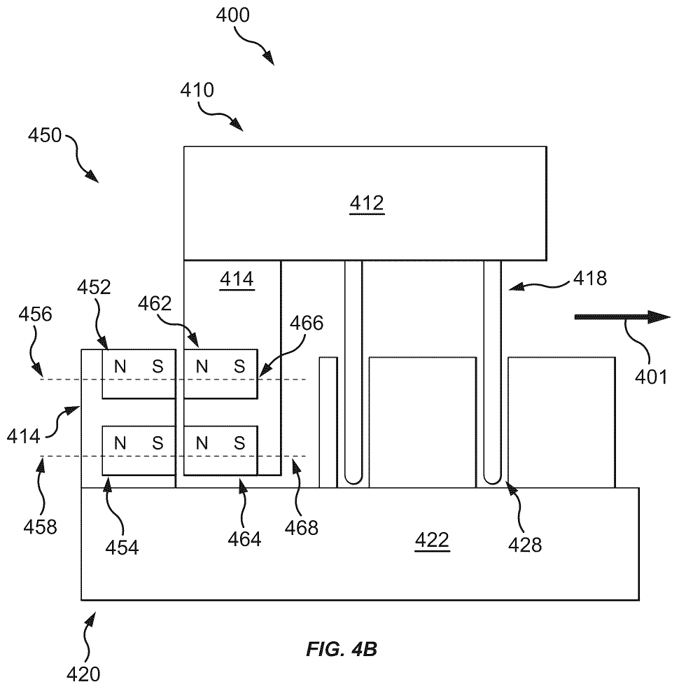

FIG. 4a illustrates a schematic cross-sectional view of an unengaged connector assembly 400 according to an embodiment. The connector assembly 400 may be used as a flyover cable assembly shown in FIG. 3. The connector assembly 400 includes a male connector 410 configured to connect with a plurality of cables 330 and having a plurality of pins 418. The connector assembly 400 also includes a female connector 420 and having a plurality of sockets 428. When the connector assembly 400 is assembled, the plurality of pins 418 are inserted into the plurality of sockets 428 along an engagement direction 402, i.e. the male connector 410 and the female connector 420 are matingly engaged. The connector assembly 400 further includes a traverse direction 401, along which the plurality of pins 418 and the plurality of 428 are arranged, respectively. The engagement direction 402 is generally orthogonal to the traverse direction 401. Either the male connector 410 or the female connector 420 may be a movable connector. For example, the male connector 410 may be movable, while the female connector 420 may be fixed to another device, such as the package substrate 122. Or, the female connector 420 may be movable, while the male connector 410 may be fixed to another device, such as the package substrate 122.

The male connector 410 includes a coupling base 412, side walls 414, 415, and the plurality of pins 418. The coupling base 412 couples one end of the plurality of the pins 418 with the plurality of cables 330. The side walls 414, 415 couple with the base 412 and surround the plurality of the pins 418. The side walls 414, 415 are disposed on opposite sides of the male connector 410 and protect the plurality of the pins 418 from physical impact. In an embodiment, the side walls 414, 415 include a plurality of magnetic components 416 and 417 disposed along the side surfaces of the side walls 414. The plurality of magnetic components 416 and 417 together with magnetic components disposed on the female connector form a magnetic guide that helps align the two connectors properly while mating.

The female connector 420 includes a coupling base 422, side walls 424, 425, and the plurality of sockets 428. The coupling base 422 couples one end of the plurality of the sockets 428 with the circuitry 160 of the package substrate 122 (shown in FIG. 1). The side walls 424, 425 couples with the base and surrounds the plurality of the sockets 428. The side walls 424, 425 are disposed at opposite sides of the female connector 420 and protect plurality of the sockets 428 from physical impact. As shown in FIG. 4, the female connector 420 are configured to enclose the male connector 410. The side walls 424, 425 of the female connector 420 form a compartment 442 having a size and shape slightly larger than the male connector 410 such that the side walls 424, 425 of the female connector 420 can engage with an outer surface of the side walls 414 and 425 of the male connector 410. In another example, the female connector 420 may be enclosed by the male connector 410. In an embodiment, the side walls 424, 425 of the female connector 420 include a plurality of magnetic components 426 and 427, which are configured to magnetically interact with the magnetic components 416 and 417.

According to an embodiment, a magnetic guide of the connector assembly 400 is configured to provide force feedback to a use who assembles the male connector assembly 400. The magnetic guide is formed by a plurality of pairs of magnetic components. Each pair includes at least two magnetic components disposed on the female connector and the male connector, respectively. For example, the magnetic components 416 of the male connector 410 and the magnetic component 426 of the female connector 410 form a first pair, while the magnetic components 417 and 426 form a second pair. In an embodiment, the magnetic guide of the connector assembly 400 may include a greater number of pairs of magnetic components, which can be disposed at various locations along the side walls.

The magnetic interactions among the magnetic components can provide a force feedback to a user who is handling the two connectors. The force feedback assists the user to properly align the two connectors and/or avoid mistakes in the assembling process. In an example, the magnetic interactions are configured to generate a repulsion force when the two connectors are incorrectly aligned, which can push the two connectors away from each other. When the two connectors are properly positioned adjacent to each other, the magnetic interactions are configured to generate an attraction force, which can pull the two connectors into more properly aligned position. The user can also rely on the magnitude of the attraction force to find the position that better aligns the two connectors. For example, the user may move the movable connector along different directions and find out which direction would produce a stronger attraction force. In an example, the position that generates the strongest attraction force indicates an accurately aligned position between the two connectors.

The magnetic guide can generate magnetic interactions among the pairs of magnetic components before the two connectors mechanically engage with each other. In an example, the first pair of magnetic components 416 and 426 are disposed in proximity to end surfaces 430 and 434, respectively. The magnetic components 417 and 427 are also disposed in proximity to end surface 432, and 436, respectively. With magnetic components disposed at the end surfaces of each connector, the magnetic components of each pair will start generating magnetic interactions before the plurality of pins 418 and the plurality of sockets 428 are engaged. Thus, the magnetic guide can act earlier than any other mechanical guides or locking mechanism of the connector assembly take effect.

To generate a magnetic attraction force for a proper alignment, the magnetic components of each pair is configured to have respective magnetic axes reversed relative to each other. As shown in FIG. 4a, the magnetic component 416 has a magnetic axis 438 that has magnetic poles arranged in an N-S order along the traverse direction 401. The magnetic component 426 has a magnetic axis 440 that has magnetic poles arranged in an S-N order along the traverse direction 401 that is out of phase with the N-S order of the magnetic component 416. When the male connector 410 and the female connector 420 are adjacent to each other in a roughly correct position, the N pole of the magnetic component 416 will be in close proximity to and attracted to the S pole of the magnetic component 426. A user can rely on this attraction force to find the proper alignment between the magnetic axes 438 and 440, which is used as an indicator that the two connectors are aligned for the mechanical engagement.

To warn a user of a completely wrong alignment, the corresponding magnetic components of facing each other from the different pairs are configured to generate repulsion forces (due to the magnetic components having the same polarity) when brought in close proximity to each other. As shown in FIG. 4a, the magnetic components 416 and 417 belong to different pairs and are disposed in different locations, such as on the opposite side walls of the male connector 410. In an embodiment, the magnetic components 416 and 417 are configured to have the same magnetic axes. For example, the magnetic poles of the magnetic component 416 are arranged in an N-S order along the traverse direction 401, while the magnetic poles of the magnetic component 417 are also arranged in an N-S order along the traverse direction 401. With this configuration, if the male connector 410 has been flipped 180 degrees around the engagement direction 402 (completely wrong alignment) and brought close to the female connector 420, the S pole of the magnetic component 417 will face the S pole of the magnetic component 426. As the two poles have the same polarity, a repulsion force is generated. The repulsion force becomes stronger when the two connectors move closer to each other, which can warn the user that the two connectors are in a completely wrong alignment.

To generate stronger magnetic interactions, the magnetic components in a same pair are disposed at locations that can be brought adjacent to each other when the two connectors are engaged. The locations include side surfaces of the side walls. In the example shown in FIG. 4 where the female connector 420 is configured to enclose the male connector 410, the magnetic components 416 and 417 are disposed in outer side surfaces of the side wall 414 and 415, and the magnetic components 426 and 427 are disposed in inner side surfaces of the side walls 424 and 425. Thus, when the side wall 414 is inserted into the compartment 442, the magnetic component 416 can face directly to the magnetic component 426. In another example where the female connector 420 is configured to be enclosed by the male connector 410, the magnetic components 416 and 417 may be disposed in inner side surfaces of the side wall 414 and 415, and the magnetic components 426 and 427 are disposed in outer side surfaces of the side walls 424 and 425.

FIG. 4b illustrates a schematic cross-sectional view of magnetic components of an engaged connector assembly 450, according to an embodiment. The engaged connector assembly 450 has the pins 418 inserted into the sockets 420 and the side wall 414 and the side wall 424 abutting each other. In an embodiment, the side wall 414 has at least two magnetic components 462 and 464 with the magnetic 464 disposed at an end of the side wall 414 and the other magnetic component 462 spaced away from the magnetic component 464. The side wall 424 also has at least two magnetic components 452 and 454 with the magnetic 452 disposed at an end of the side wall 424 and the other magnetic component 454 spaced away from the magnetic component 452. In the engaged connector assembly 450, the magnetic component 452 has a magnetic axis 456 arranged along the transverse direction 401 and aligned with the magnetic axis 466 of the magnetic component 462. In other words, the magnetic poles of the magnetic components 452 and 462 are alternately aligned along the transverse direction, such as N-S-N-S or S-N-S-N. Similarly, the magnetic component 454 has a magnetic axis 458 arranged along the transverse direction 401 and aligned with the magnetic axis 468 of the magnetic component 464. In other words, the magnetic poles of the magnetic components 454 and 464 are alternately aligned along the transverse direction, such as N-S-N-S or S-N-S-N.

In an embodiment, the magnetic components 416, 417, 426, 427, 452, 454, 462, and 464 may have a dimension, such as thickness and height, smaller than that of the side walls such that the magnetic components can be embedded or enclosed by the side walls. A magnetic component with a small physical form factor can cause less electromagnetic interference with the data or signal transmitted by the cables 330. In another embodiment, the magnetic components may have the same thickness of the side walls to simply the manufacturing process of the connector assembly.

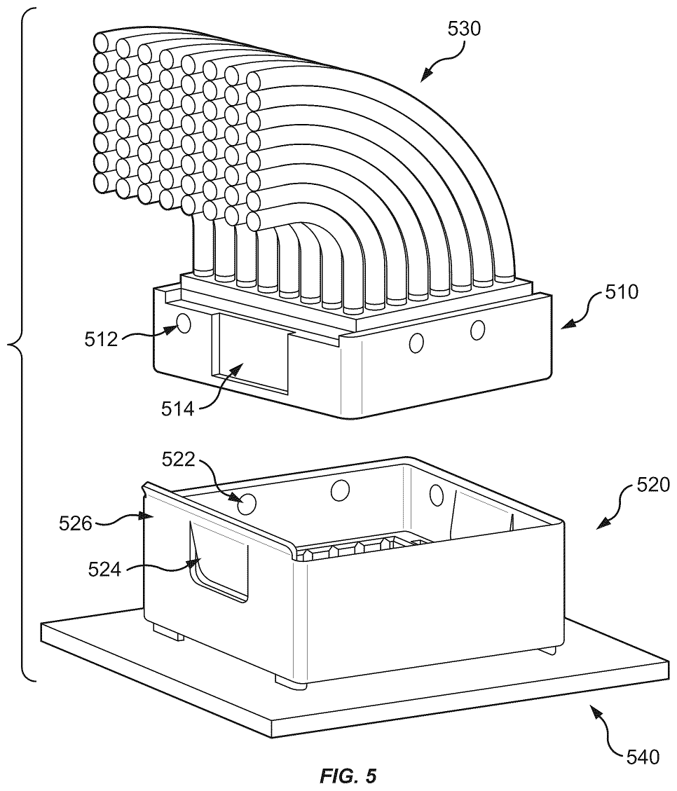

FIG. 5 illustrates a schematic perspective view of a connector assembly 500, according to an embodiment. The connector assembly 500 includes a male connector 510 and a female connector 520. The male connector 510 is electrically coupled with a plurality of cables 530. The male connector includes a magnetic component 512 and a depression 514. The female connector 520 is electrically coupled with a substrate 540. The female connector 520 includes a magnetic component 522 and a tab 524. The magnetic components 512 and 522 form a magnetic guide as described above. In an embodiment, the depression 514 and the tab 524 are configured to form a mechanical locking mechanism 526, which can prevent the male connector 510 from disengaging with the female connector 520. The mechanical locking mechanism 526 may alternatively be a detent, latch, clip, snap or other suitable device. In an embodiment, each side wall of the connector assembly 500 may include one or more magnetic components. In an example, the magnetic component may have a circular shape as shown in FIG. 4. In another example, the magnetic component may have a strip shape with the longitudinal dimension extending along the engagement direction. In yet another example, the magnetic components 522 and 512 may have identical sizes or one of the magnetic components may have a larger size than the other one.

The connector assembly as set forth in the present disclosure is not limited to the application in an IC package assembly. The connector assembly as set forth in the present disclosure may be used as any connector assembly of a male-female type. In one example, electronic systems may use one or more cabinets, chassis, racks or PCB boards to support electronics and/or connect with external cables. These cabinets, chassis, racks, or PCB boards include electrical terminals, connectors, plugs and ports for connections. For example, these electric terminals connectors, plugs and ports may be used for display port, mini display port, HDMI, DVI-I, DVI-D, DMS-59, VHDCI, VGA, AXI, power, USB, and/or FMC. Examples of these electric terminals, connectors, plugs and ports may include power connectors, audio/video connectors, PCB connectors, docking connectors, terminal blocks, ribbon connectors, PCB terminals, wire to board connectors, LVDS connectors, and etc. Any of these electrical terminals may be implemented by the connector assembly, according to an embodiment of the present disclosure.

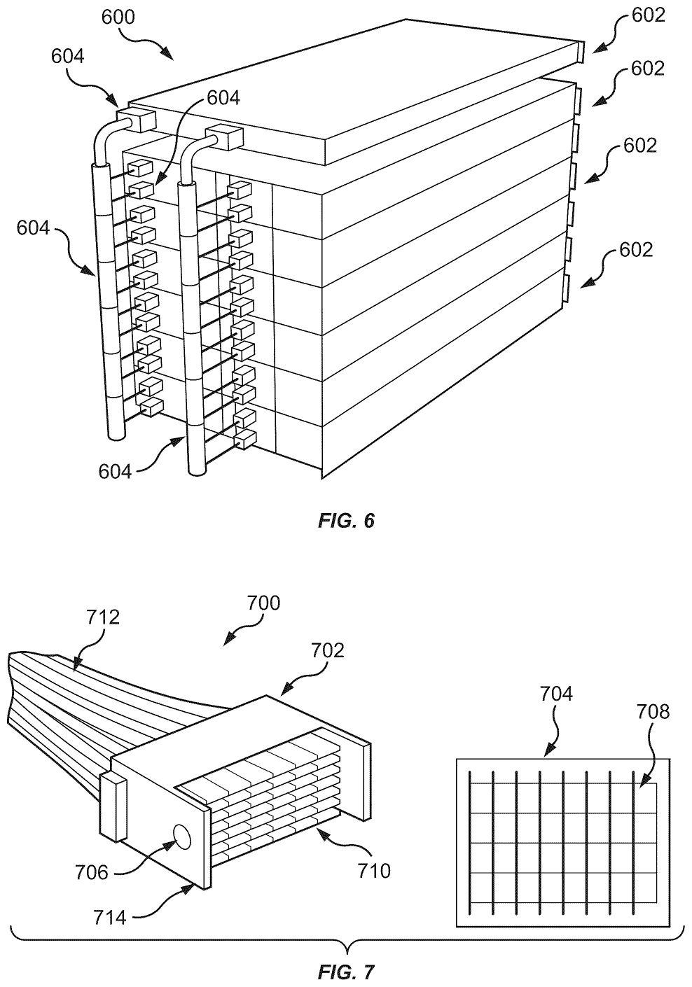

FIG. 6 illustrates a server machine 600 having a plurality of connector assemblies, according to an embodiment of the present disclosure. The server machine 600 may be a storage server, a networking server, a computing server, or any other servers. In an embodiment, the server machine 600 is constructed according to the specification of the Open19 Project. The sever machine 600 includes a plurality of racks 602 stacked together. The plurality of racks 602 may include a power rack for managing power, a network rack for transceiving data, a storage rack for data storage, and any other suitable racks. Each rack 602 includes a plurality of connector assemblies 604 configured to connect the rack 602 with a plurality of cables 606. As the plurality of racks are densely stacked in the server machine 600, the spaces between adjacent connector assemblies 604 are tight. As result, a user, who is connecting the cables with the racks, may not have a clear view to properly align the male and female connectors. In an embodiment, the connector assembly 604 is configured to include a magnetic guide according to an embodiment of the present disclosure. The magnetic guide assists the user to position a movable connector properly by providing feedbacks via magnetic interactions.

FIG. 7 illustrates a connector assembly 700 for a network card, according to an embodiment of the present disclosure. The connector assembly 700 includes a male connector 702 coupled with a plurality of cables 712. The male connector 702 is also coupled with a female connector 704 attached to the network card (not shown). The male connector 702 includes a plurality of pins 710 and a magnetic component 706 disposed on an outer side surface of a side wall 714. The female connector 704 includes a plurality of sockets 708 configured to mate with the pins 710. As shown in FIG. 7, the plurality of pins 710 and sockets 708 are densely packed and can be easily damaged when they are forced to engage. The connector assembly 700, with assisted by the magnetic guide according to an embodiment of the present disclosure, can guide a user to an assured alignment positions, which will avoid physical damages to the pins or the sockets.

While the foregoing is directed to embodiments of the present invention, other and further embodiments of the invention may be devised without departing from the basic scope thereof, and the scope thereof is determined by the claims that follow.

What is claimed is:

1. A connector assembly comprising:
a male connector comprising a first side wall protecting a plurality of pins, the first side wall comprising a first magnetic component contained in a side surface of the first side wall, the side surface of the first side wall being aligned with an engaging direction of the connector assembly; and
a female connector comprising a second side wall protecting a plurality of sockets configured to receive the plurality of the pins, the second side wall comprising a second magnetic component contained in a side surface of the second side wall, the side surface of the second side wall being aligned with the engaging direction of the connector assembly,
wherein the first magnetic component and the second magnet component are configured to be disposed adjacent to each other when the male connector engages with the female connector.

2. The connector assembly of claim 1, wherein the first magnetic component has a first magnetic axis traversing the engaging direction of the connector assembly.

3. The connector assembly of claim 2, wherein the second magnetic component has a second magnetic axis configured to be parallel with the first magnetic axis.

4. The connector assembly of claim 3, wherein the first magnetic axis and the second magnetic axis are reversed relative to each other.

5. The connector assembly of claim 1, wherein the female connector is configured to enclose the male connector, and the first magnetic component is disposed in an outer surface of the first side wall.

6. The connector assembly of claim 5, wherein the second magnetic component is disposed in an inner surface of the second side wall.

7. The connector assembly of claim 1, wherein the first magnetic component is disposed in proximity to an end surface of the first side wall facing the second side wall, and the second magnetic component is disposed in proximity to an end surface of the second side wall facing the first side wall.

8. The connector assembly of claim 1, wherein the male connector comprises a third side wall comprising a third magnetic component, and the third magnetic component has a third magnetic axis aligned with a first magnetic axis of the first magnetic component.

9. The connector assembly of claim 8, wherein the female connector comprises a fourth side wall comprising a fourth magnetic components, and the fourth magnetic component has a fourth magnetic axis reversing that of the third magnetic component.

10. The connector assembly of claim 1, wherein the first magnetic component has a thickness shorter than that of the first side wall.

11. The connector assembly of claim 10, wherein one of the first and second magnetic components has a larger size than the other one of the first and second magnetic components.

12. The connector assembly of claim 11, wherein the plurality of the pins are coupled with a plurality of cables.

13. The connector assembly of claim 12, further comprising a locking mechanism configured to maintain an engagement position between the male connector and the female connector.

14. An integrated circuit package assembly comprising:
a plurality of integrated circuit dice;
a stiffener coupled with a package substrate and surrounding the plurality of the integrated circuit dice; and
a connector assembly coupled with the stiffener, wherein the connector assembly comprises:
a male connector comprising a first side wall protecting a plurality of pins, the first side wall comprising a first magnetic component contained in a side surface of the first side wall, the side surface of the first side wall being aligned with an engaging direction of the connector assembly; and
a female connector comprising a second side wall protecting a plurality of sockets configured to receive the plurality of the pins, the second side wall comprising a second magnetic component contained in a side surface of the second side wall, the side surface of the second side wall being aligned with the engaging direction of the connector assembly,
wherein the first magnetic component and the second magnet component are configured to be disposed adjacent to each other when the male connector engages with the female connector.

15. The integrated circuit package assembly of claim 14, wherein the first magnetic component has a first magnetic axis traversing the engaging direction of the connector assembly.

16. The integrated circuit package assembly of claim 15, wherein the second magnetic component has a second magnetic axis configured to be parallel with the first magnetic axis, and the first magnetic axis and the second magnetic axis are reversed relative to each other.

17. The integrated circuit package assembly of claim 14, wherein the female connector is configured to enclose the male connector, the first magnetic component is disposed in an outer surface of the first side wall, and the second magnetic component is disposed in an inner surface of the second side wall.

18. The integrated circuit package assembly of claim 14, wherein the male connector comprises a third side wall comprising a third magnetic component, and the third magnetic component has a third magnetic axis aligned with a first magnetic axis of the first magnetic component.

19. The integrated circuit package assembly of claim 18, wherein the female connector comprises a fourth side wall comprising a fourth magnetic components, and the fourth magnetic component has a fourth magnetic axis reversing that of the third magnetic component.

20. The integrated circuit package assembly of claim 14, wherein the first magnetic component has a thickness shorter than that of the first side wall.
